(19) United States
(12) Patent Application Publication
(10) Pub. No.: US 2026/0077690 A1
(43) Pub. Date: Mar. 19, 2026

(54) VEHICLE SEAT

(71) Applicant: TOYOTA BOSHOKU KABUSHIKI KAISHA, Aichi (JP)

(72) Inventor: Shoh TERADA, Nagoya-shi (JP)

(73) Assignee: TOYOTA BOSHOKU KABUSHIKI KAISHA, Aichi (JP)

(21) Appl. No.: 19/327,115

(22) Filed: Sep. 12, 2025

(30) Foreign Application Priority Data
Sep. 18, 2024 (JP) 2024-161125

(51) Int. Cl. B60N 2/20; B60N 2/22; B60N 2/68

(52) U.S. Cl. CPC B60N 2/20; B60N 2/22; B60N 2/682

(57) ABSTRACT

A vehicle seat includes first and second side frames that extend in seat front-rear directions; first and second coupling plates that are fixed to rear end portions of the first and second side frames respectively and that extend upward; a coupling member coupling the first and second coupling plates with each other; a back frame pivotable in the seat front-rear directions; and a walk-in mechanism, the first coupling plate including a first plate portion to which the walk-in mechanism and a first recliner are attached; a second plate portion coupled to the first side frame and located at a position displaced in seat-width directions relative to the first plate portion; and a step portion continuous with the first and second plate portions.

### CROSS-REFERENCE TO RELATED APPLICATION

This application claims the benefit of Japanese Patent Application No. 2024-161125 filed on September 18, 2024 with the Japan Patent Office, the entire disclosure of which is incorporated herein by reference.

### BACKGROUND

The present disclosure relates to a seat to be mounted in a vehicle.

For example, a coupling plate described in Japanese Unexamined Patent Application Publication No. 2014-083952 (hereinafter referred to as “Patent Document 1”) includes step portions each provided above and below a portion coupled with a coupling pipe. The coupling plate is a member that couples a side frame of a cushion frame (also referred to as a “lower arm”) and a back frame with each other.

Generally, the back frame is coupled to the coupling plate via a recliner. The coupling pipe couples the coupling plate arranged on a right side of the seat and the coupling plate arranged on a left side of the seat with each other.

### SUMMARY

Since the coupling plate described in Patent Document 1 includes the step portions each provided above and below the portion coupled with the coupling pipe, a planar part above the coupled portion naturally becomes small. Thus, it is difficult to arrange a walk-in mechanism on the planar part.

Further, in the coupling plate, since the step portions are each provided above and below the portion coupled with the coupling pipe, it is difficult to increase bending stiffness of the coupling plate against a load from seat-width directions. The present disclosure provides an example of a vehicle seat in which the aforementioned points are taken into consideration.

It is desirable that a vehicle seat to be mounted in a vehicle according to an aspect of the present disclosure comprise at least one of the elements below, for example.

Specifically, such elements are: a first side frame forming a framework of a seat cushion and extending in seat front-rear directions; a second side frame forming the framework of the seat cushion and extending in the seat front-rear directions at a position displaced in seat-width directions relative to the first side frame; a first coupling plate that is fixed to a rear end portion of the first side frame and that extends upward; a second coupling plate that is fixed to a rear end portion of the second side frame and that extends upward; a coupling member extending in the seat-width directions and coupling the first coupling plate and the second coupling plate with each other; a back frame arranged to be pivotable in the seat front-rear directions via a first recliner attached to an upper end portion of the first coupling plate and a second recliner attached to an upper end portion of the second coupling plate; and a walk-in mechanism provided on the first coupling plate for achieving at least a function that allows the seatback to be folded flat toward a seat-front side.

It is desirable that the first coupling plate include a first plate portion having a plane shape to which at least the walk-in mechanism and the first recliner are attached; a second plate portion having a plane shape that is located below the first plate portion and coupled to the first side frame, the second plate portion being located at a position displaced in the seat-width directions relative to the first plate portion; and a step portion continuous with the first plate portion and the second plate portion, the step portion being arranged closer to the first side frame than a portion of the first coupling plate to which the coupling member is coupled is.

With this configuration, the first coupling plate of the vehicle seat is formed to have fewer step portions than the coupling plate described in Patent Document 1. Accordingly, in the first coupling plate, a part of the first plate portion on which the walk-in mechanism can be arranged may be large compared to the coupling plate described in Patent Document 1. Consequently, in the first coupling plate, it may be possible to easily arrange the walk-in mechanism on the first plate portion.

Furthermore, since the first coupling plate is formed to have fewer step portions than the coupling plate described in Patent Document 1, the first coupling plate may have a greater bending stiffness against a load from the seat-width directions than the coupling plate described in Patent Document 1.

The vehicle seat may have the following configurations, for example.

Specifically, it is desirable that, when an imaginary line depicted by a boundary between the step portion and the first plate portion is referred to as a boundary line, at least a part of the boundary line that includes a range below the coupling member be formed in a curve and other parts of the boundary line be formed in straight lines.

Additionally, it is desirable that the first coupling plate be located opposite to a side where a buckle for a seat belt is located, and the second coupling plate be located on the side where the buckle for the seat belt is located.

Additionally, it is desirable that the second coupling plate include a first plane portion having a plane shape to which a second recliner is attached; a second plane portion having a plane shape that is located below the first plane portion and coupled to the second side frame, the second plane portion being located at a position displaced in the seat-width directions relative to the first plane portion; and a step portion continuous with the first plane portion and the second plane portion, the step portion being arranged closer to the second recliner than a portion of the second coupling plate to which the coupling member is coupled is.

With this configuration, in the second coupling plate, a portion to which the coupling member is coupled is positioned in the second plane portion. Accordingly, in the second coupling plate, when a tensile force acting on the seat belt is transmitted from the second side frame via the second coupling plate to the coupling member, there is no step portion that may hinder the transmission of the tensile force. As a result of this, it may be possible to transmit the tensile force acting on the seat belt to the coupling member in an efficient manner via the second coupling plate.

### BRIEF DESCRIPTION OF THE DRAWINGS

An example embodiment of the present disclosure will be described hereinafter with reference to the accompanying drawings, in which:

FIG. 1 is a view showing a vehicle seat according to a first embodiment;

FIG. 2 is a view showing a coupling structure between a back frame and a cushion frame;

FIG. 3 is a view showing a first coupling plate according to the first embodiment;

FIG. 4 is a view showing a part of the first coupling plate according to the first embodiment;

FIG. 5 is a view showing a second coupling plate according to the first embodiment; and

FIG. 6 is a view showing a part of the second coupling plate according to the first embodiment.

### DETAILED DESCRIPTION OF EXEMPLARY EMBODIMENTS

The embodiments below show examples of embodiments that fall within the technical scope of the present disclosure. The appended claims are not limited to any specific configuration, structure, or the like described in the following embodiments.

The embodiments show examples where a vehicle seat according to the present disclosure is applied to a seat to be mounted in a vehicle, such as an automobile (hereinafter referred to as “vehicle seat”). Arrows for indicating directions, oblique lines, and the like in each drawing are provided to facilitate understanding of mutual relations between the drawings, and the shapes of members or portions, and the like.

Thus, the vehicle seat is not limited to be oriented as shown in each drawing. The directions shown in the drawings are directions in a state in which the vehicle seat according to each of the embodiments is mounted in the automobile. A drawing with oblique lines does not necessarily represent a cross-sectional view.

With respect at least to a member or a portion explained with a reference numeral, at least one such member or portion is provided unless it is specified using a term such as “only one”. Unless it is specified using a term such as “only one”, two or more of such members or portions may be provided. The vehicle seat disclosed in the present disclosure includes at least one element, such as a member or a portion explained with a reference numeral, or a structural component shown in the drawings.

### [First Embodiment]

### <1. Overview of Vehicle Seat>

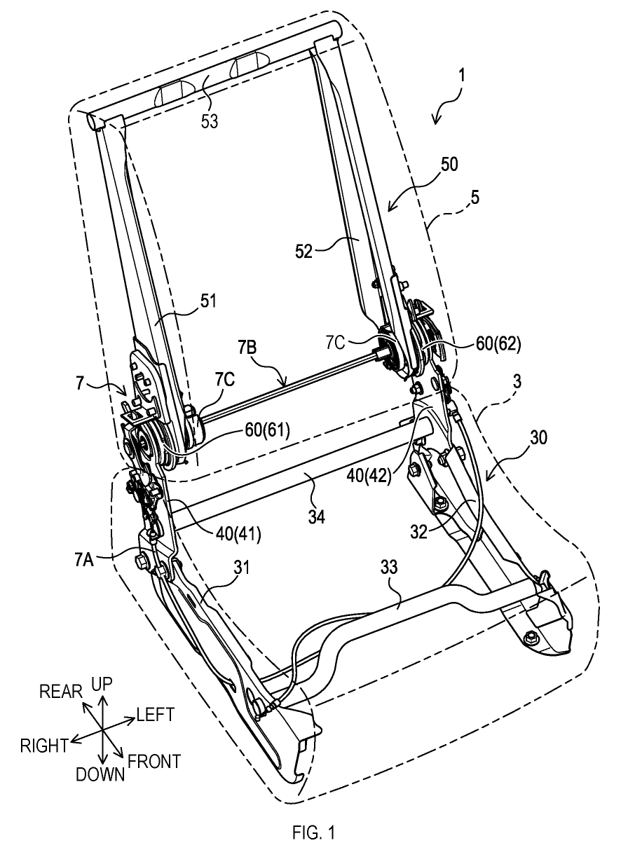

A vehicle seat 1 includes at least a seat cushion 3 and a seatback 5, as shown in FIG. 1. The seat cushion 3 is configured to support the buttocks of an occupant. The seatback 5 is configured to support the back of the occupant.

The seat cushion 3 is mounted in the vehicle via a sliding device (not shown). The sliding device supports the seat cushion 3, namely the vehicle seat 1, such that the vehicle seat 1 is slidable in seat front-rear directions.

The sliding device includes at least a movable rail and a fixed rail. The fixed rail is immovably fixed to the vehicle. The movable rail is slidably coupled to the fixed rail. The vehicle seat 1 is coupled to the movable rail.

The seat cushion 3 includes a cushion frame 30 and a cushion pad (not shown). The cushion frame 30 is a framework of the seat cushion 3 and includes at least a first side frame 31 and a second side frame 32.

The first side frame 31 is a lower arm that is provided on one side of the seat in seat-width directions and extends in the seat front-rear directions. The second side frame 32 is a lower arm that is provided at a position displaced to the other side of the seat in the seat-width directions relative to the first side frame 31 and that extends in the seat front-rear directions.

A front end portion of the first side frame 31 and a front end portion of the second side frame 32 are coupled with each other by a coupling pipe 33. The coupling pipe 33 extends in the seat-width directions to couple the first side frame 31 and the second side frame 32 with each other.

The seatback 5 includes a back frame 50 and a back pad (not shown). The back frame 50 is a framework of the seatback 5 and includes at least a first side frame 51 and a second side frame 52.

The first side frame 51 is a member that is provided on the one side of the seat in the seat-width directions and extends in substantially up-down directions. The second side frame 52 is a member that is provided at a position displaced to the other side of the seat in the seat-width directions relative to the first side frame 51 and that extends in the substantially up-down directions.

An upper end portion of the first side frame 51 and an upper end portion of the second side frame 52 are coupled with each other by a coupling pipe 53. The coupling pipe 53 extends in the seat-width directions to couple the first side frame 51 and the second side frame 52 with each other.

The cushion frame 30 and the back frame 50 are coupled with each other via coupling plates 40 (first coupling plate 41, second coupling plate 42), recliners 60 (recliners 61, 62), and the like. The recliners 60 are devices configured to change or maintain an angle of the back frame 50 relative to the cushion frame 30.

Each of the recliners 61 and 62 is arranged vertically above its corresponding movable rail. In other words, each of the recliners 61 and 62 projected onto an imaginary horizontal plane at least partially overlaps its corresponding movable rail projected onto the imaginary horizontal plane.

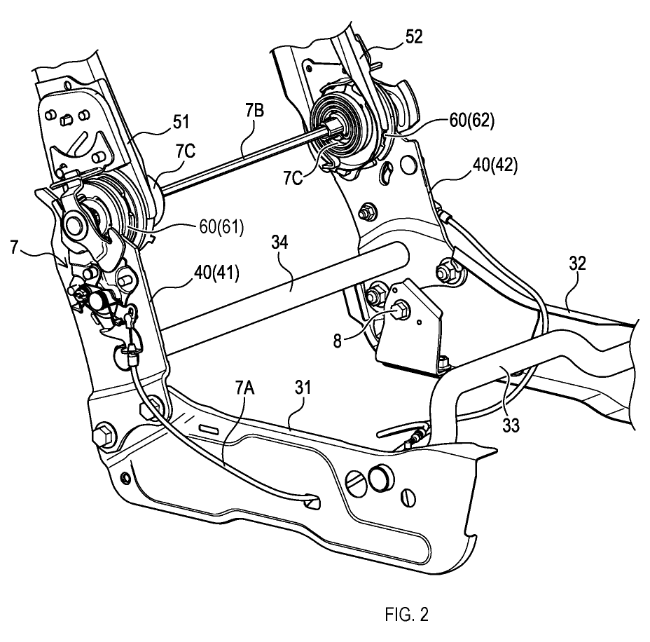

As shown in FIG. 2, the first coupling plate 41 is a plate material that is fixed to a rear end portion of the first side frame 31 and that extends upward. The recliner 61 is coupled to an upper end portion of the first coupling plate 41. A lower end portion of the first side frame 51 is coupled to the recliner 61.

The recliner 61 and the first side frame 51 are arranged on a second coupling plate 42 side relative to the first coupling plate 41. On a side of the first coupling plate 41 opposite from the recliner 61, a walk-in mechanism 7 is arranged.

The walk-in mechanism 7 is a mechanism for achieving at least a function that allows the seatback 5 to be folded flat toward a seat-front side. The walk-in mechanism 7 according to the present embodiment is a mechanism configured to release the recliners 60 and the sliding device from a locked mode simultaneously.

Specifically, the walk-in mechanism 7 according to the present embodiment is a mechanism for achieving at least a function that allows the seat cushion 3 to slide in the seat front-rear directions in conjunction with a motion in which the seatback 5 is folded flat toward the seat-front side.

Specifically, when an operation cable 7A for the walk-in mechanism 7 is operated, a rod 7B is rotated and the recliners 61, 62 are released from their locked mode, and the lock of the sliding device is also released. As a result of this, the seatback 5 is folded flat toward the seat-front side due to an elastic force of spiral springs 7C.

The second coupling plate 42 is a plate material that is fixed to a rear end portion of the second side frame 32 and that extends upward. The recliner 62 is coupled to an upper end portion of the second coupling plate 42. A lower end portion of the second side frame 52 is coupled to the recliner 62.

The first coupling plate 41 and the second coupling plate 42 are coupled with each other by a coupling pipe 34. The coupling pipe 34 extends in the seat-width directions to couple the first coupling plate 41 and the second coupling plate 42 with each other.

In the present embodiment, the first coupling plate 41 is located opposite to a side where a buckle for a seat belt is located, and the second coupling plate 42 is located on the side where the buckle for the seat belt is located. A pin 8 shown in FIG. 2 is a portion to which a belt (not shown) on the buckle side is coupled.

### <2. Details of Coupling Plates>

### <2.1 First Coupling Plate>

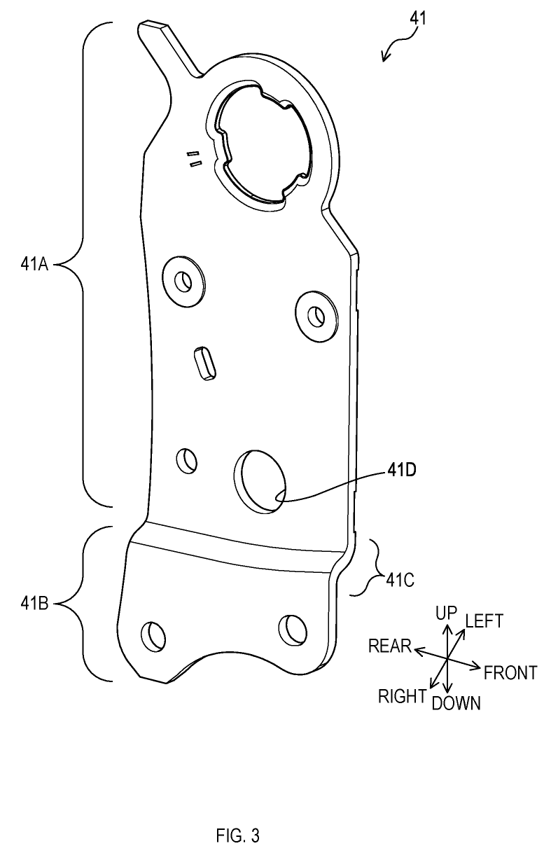

As shown in FIG. 3, the first coupling plate 41 includes a first plate portion 41A, a second plate portion 41B, and a step portion 41C. In the present embodiment, a single plate material is pressed to form the first plate portion 41A, the second plate portion 41B, and the step portion 41C integrally.

The first plate portion 41A is a plate portion having a plane shape to which the walk-in mechanism 7 and the recliner 61 are attached. The walk-in mechanism 7 is arranged on one side surface of the first plate portion 41A. The recliner 61 is arranged on the other side surface of the first plate portion 41A.

The second plate portion 41B is a plate portion having a plane shape that is provided below the first plate portion 41A and is coupled to the first side frame 31. The second plate portion 41B is located at a position displaced in a seat-width direction relative to the first plate portion 41A and is parallel to the first plate portion 41A.

The second plate portion 41B according to the present embodiment is located at a position displaced to a side where the walk-in mechanism 7 is located relative to the first plate portion 41A. More specifically, the second plate portion 41B is located at a position displaced to a right side of the seat relative to the first plate portion 41A. The second plate portion 41B is fixed to a right side surface of the first side frame 31 by bolts.

The step portion 41C is a portion continuous with the first plate portion 41A and the second plate portion 41B, and is arranged closer to the first side frame 31 than a portion of the first coupling plate 41 to which the coupling pipe 34 is coupled (i.e., a through hole 41D shown in FIG. 3) is. In other words, the step portion 41C is arranged below the through hole 41D.

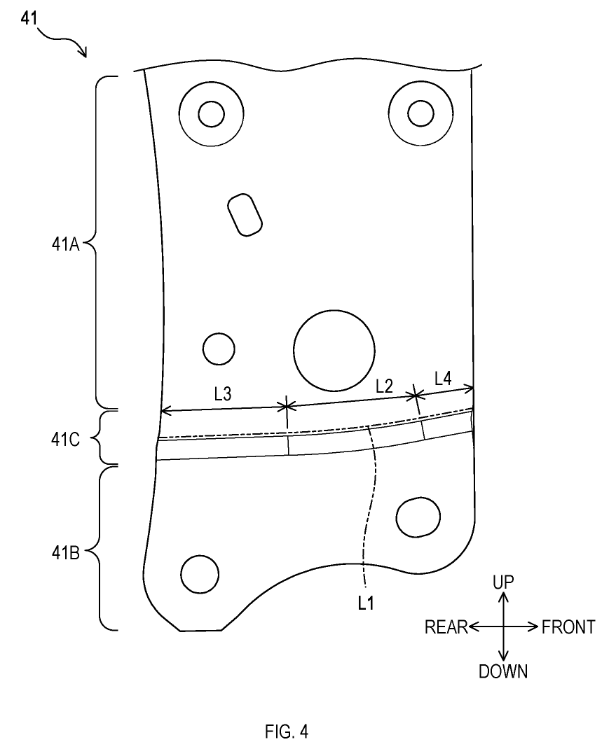

Additionally, as shown in FIG. 4, when an imaginary line depicted by a boundary between the step portion 41C and the first plate portion 41A is defined as a boundary line L1, at least a part L2 of the boundary line L1 that includes a range below the through hole 41D is formed in a curve, and other parts L3, L4 of the boundary line L1 are formed in straight lines.

### <2.2 Second Coupling plate>

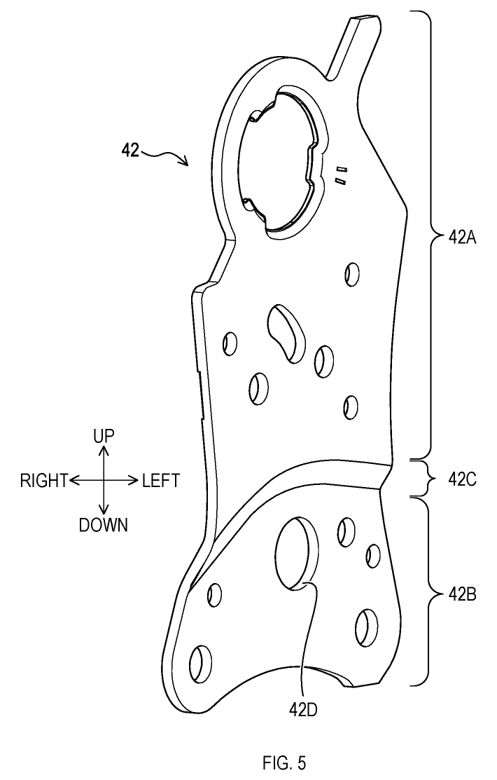

As shown in FIG. 5, the second coupling plate 42 includes a first plate portion 42A, a second plate portion 42B, and a step portion 42C. In the present embodiment, a single plate member is pressed to form the first plate portion 42A, the second plate portion 42B, and the step portion 42C integrally.

The first plate portion 42A is a first plane portion having a plane shape to which the recliner 62 is attached. The recliner 62 is arranged on a side of the first plate portion 42A that is closer to the first coupling plate 41, that is, on the right side of the first plate portion 42A.

The second plate portion 42B is a plate portion that is provided below the first plate portion 42A and is coupled to the second side frame 32. The second plate portion 42B is a second plane portion having a plane shape that is located at a position displaced in the seat-width directions relative to the first plate portion 42A and is parallel to the first plate portion 42A.

The second plate portion 42B according to the present embodiment is located at a position displaced to a first coupling plate 41 side relative to the first plate portion 42A, that is, displaced to the right side. The second plate portion 42B is fixed to a right side surface of the second side frame 32 by bolts.

The step portion 42C is a portion continuous with the first plate portion 42A and the second plate portion 42B, and is arranged closer to the recliner 62 than a portion of the second coupling plate 42 to which the coupling pipe 34 is coupled (i.e., a through hole 42D shown in FIG. 5) is. In other words, the step portion 42C is arranged above the through hole 42D.

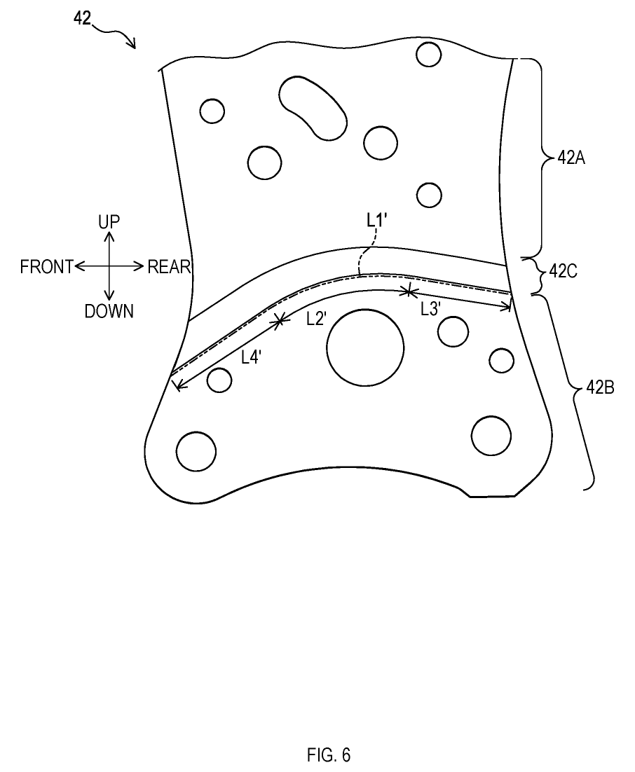

As shown in FIG. 6, when an imaginary line depicted by a boundary between the step portion 42C and the second plate portion 42B is defined as a boundary line L1’, at least a portion L2’ of the boundary line L1’ that includes a range above the through hole 42D is formed in a curve, and other parts L3’, L4’ of the boundary line L1’ are formed in straight lines.

### <3. Features of Vehicle Seat of Present Embodiment>

The first coupling plate 41 in the vehicle seat 1 according to the present embodiment is formed to have fewer step portions than the coupling plate described in Patent Document 1. Specifically, the number of the step portion 41C of the first coupling plate 41 is one. In contrast, the number of the step portions of the coupling plate described in Patent Document 1 is two.

Accordingly, in the first coupling plate 41, a part of the first plate portion 41A on which the walk-in mechanism 7 can be arranged may be larger than that of the coupling plate described in Patent Document 1. Consequently, in the first coupling plate 41, it may be possible to easily arrange the walk-in mechanism 7 on the first plate portion 41A.

Additionally, since the first coupling plate 41 is formed to have fewer step portions than the coupling plate described in Patent Document 1, the first coupling plate 41 may have a greater bending stiffness against a load from the seat-width directions than the coupling plate described in Patent Document 1.

At least a part of the boundary line L1 in the first coupling plate 41 that includes a range below the coupling pipe 34 is formed in a curve, and other parts of the boundary line L1 are formed in straight lines. This configuration may inhibit reduction of stiffness around the through hole 41D.

The step portion 42C of the second coupling plate 42 is arranged closer to the recliner 62 than a portion to which the coupling pipe 34 is coupled is. In this way, in the second coupling plate 42, the portion to which the coupling pipe 34 is coupled is positioned in the second plate portion 42B.

Consequently, in the second coupling plate 42, when a tensile force acting on the seat belt is transmitted from the second side frame 32 via the second coupling plate 42 to the coupling pipe 34, there is no step portion that may hinder the transmission of the tensile force. As a result of this, it may be possible to transmit the tensile force acting on the seat belt to the coupling pipe 34 via the second coupling plate 42 in an efficient manner.

### <Other Embodiments>

The walk-in mechanism 7 according to the aforementioned embodiment is a mechanism for achieving a function that allows the seat cushion 3 to slide in the seat front-rear directions in conjunction with the motion in which the seatback 5 is folded flat toward the seat-front side.

However, the present disclosure is not limited thereto. Specifically, in the present disclosure, it is sufficient if the walk-in mechanism 7 can achieve at least a function that allows the seatback 5 to be folded flat toward the seat-front side, for example.

In the aforementioned embodiment, the first coupling plate 41 and the second coupling plate 42 have different structures. However, the present disclosure is not limited thereto. In other words, in the present disclosure, the first coupling plate 41 and the second coupling plate 42 may have the same structure, for example.

In the aforementioned embodiment, the second plate portions 41B, 42B are located at positions displaced to the right side relative to the first plate portions 41A, 42A, respectively. However, the present disclosure is not limited thereto. In other words, in the present disclosure, the second plate portions 41B, 42B may be located at positions displaced to the left side relative to the first plate portions 41A, 42A, respectively, for example.

In the aforementioned embodiment, at least a part of each of the boundary lines L1, L1’ that includes a range below or above the coupling pipe 34 is formed in a curve and other parts of each of the boundary lines L1, L1’ are formed in straight lines. However, the present disclosure is not limited thereto.

Specifically, in the present disclosure, each of the entire boundary lines L1, L1’ may be formed to be a curve or a straight line, for example. It is desirable that a radius of curvature of the curve part of each of the boundary lines L1, L1’ be as large as possible.

In the aforementioned embodiments, the vehicle seat of the present disclosure is mounted in the automobile. However, the present disclosure is not limited to this configuration. The present disclosure may be applied to a seat used in a vehicle such as a railroad vehicle, a ship, a boat, or an aircraft, or to a stationary seat used in a theater or a household, for example.

Furthermore, the present disclosure is not limited to the aforementioned embodiments as long as it falls within the spirit of the disclosure described in the aforementioned embodiments. Accordingly, at least two of the aforementioned embodiments may be combined, or some of the elements shown in the drawings or described with reference to assigned reference numerals in the aforementioned embodiments may be eliminated.

What is claimed is:

1. A vehicle seat to be mounted in a vehicle, the vehicle seat comprising:
a first side frame forming a framework of a seat cushion and extending in seat front-rear directions;
a second side frame forming the framework of the seat cushion and extending in the seat front-rear directions at a position displaced in seat-width directions relative to the first side frame;
a first coupling plate that is fixed to a rear end portion of the first side frame and that extends upward;
a second coupling plate that is fixed to a rear end portion of the second side frame and that extends upward;
a coupling member extending in the seat-width directions and coupling the first coupling plate and the second coupling plate with each other;
a back frame arranged to be pivotable in the seat front-rear directions via a first recliner attached to an upper end portion of the first coupling plate and a second recliner attached to an upper end portion of the second coupling plate; and
a walk-in mechanism provided on the first coupling plate for achieving at least a function that allows the seatback to be folded flat toward a seat-front side,
the first coupling plate including:
a first plate portion having a plane shape to which the walk-in mechanism and the first recliner are attached;
a second plate portion having a plane shape located below the first plate portion and coupled to the first side frame, the second plate portion being located at a position displaced in the seat-width directions relative to the first plate portion; and
a step portion continuous with the first plate portion and the second plate portion, the step portion being arranged closer to the first side frame than a portion of the first coupling plate to which the coupling member is coupled is.

2. The vehicle seat according to claim 1,
wherein, when an imaginary line depicted by a boundary between the step portion and the first plate portion is defined as a boundary line, at least a part of the boundary line that includes a range below the coupling member is formed in a curve and other parts of the boundary line are formed in straight lines.

3. The vehicle seat according to claim 1,
wherein the first coupling plate is located opposite to a side where a buckle for a seat belt is located,
wherein the second coupling plate is located on the side where the buckle for the seat belt is located, and
wherein the second coupling plate includes:
a first plane portion having a plane shape to which at least the second recliner is attached;
a second plane portion having a plane shape located below the first plane portion and coupled to the second side frame, the second plane portion being located at a position displaced in the seat-width directions relative to the first plane portion; and
a step portion continuous with the first plane portion and the second plane portion, the step portion being arranged closer to the second recliner than a portion of the second coupling plate where the coupling member is coupled is.

4. The vehicle seat according to claim 2,
wherein the first coupling plate is located opposite to a side where a buckle for a seat belt is located,
wherein the second coupling plate is located on the side where the buckle for the seat belt is located, and
wherein the second coupling plate includes:
a first plane portion having a plane shape to which at least the second recliner is attached;
a second plane portion having a plane shape located below the first plane portion and coupled to the second side frame, the second plane portion being located at a position displaced in the seat-width directions relative to the first plane portion; and
a step portion continuous with the first plane portion and the second plane portion, the step portion being arranged closer to the second recliner than a portion of the second coupling plate where the coupling member is coupled is.
